(19) United States
(12) Patent Application Publication
(10) Pub. No.: US 2026/0351122 A1
(43) Pub. Date: Nov. 5, 2026

(54) SYSTEMS, APPARATUSES, METHODS, AND COMPUTER PROGRAM PRODUCTS FOR SMART CONNECTED INTERFACE FOR MULTIMODAL OPEN WORLD DATA INTEGRATION

(71) Applicant: Honeywell International Inc., Charlotte, NC (US)

(72) Inventors: Sreenivasan Govindillam, Bangalore (IN); Ravikumar Selvarajan, Madurai (IN); Sri Harsha Kosuri, Bangalore (IN)

(21) Appl. No.: 19/288,156

(22) Filed: Aug. 1, 2025

(30) Foreign Application Priority Data
May 2, 2025 (IN) 202511042703

(51) Int. Cl. G08G 5/34; G06F 40/205; G08G 5/32

(52) U.S. Cl. CPC G08G 5/34; G06F 40/205; G08G 5/32

(57) ABSTRACT

Embodiments of the present disclosure provide techniques that include receiving a command associated with a flight; generating, using a conversion model, an API request corresponding to the command based on an API schema associated with a connected API for one or more connected applications, wherein the API request comprises one or more flight parameters from the command mapped to a lexicon associated with the API schema, performing an impact assessment based on the API request to generate predicted impact data, generating a classification for the API request based on the predicted impact data, and initiating the performance of one or more implementation actions based on the classification.

### CROSS-REFERENCE TO RELATED APPLICATIONS

This application claims the benefit of India Provisional Patent Application No. 202511042703, filed May 2, 2025, the entire contents of which are incorporated by reference herein.

### TECHNOLOGICAL FIELD

Embodiments of the present disclosure generally relate to open world data integration; and, particularly to systems, apparatuses, methods, and computer program products for smart connected interface for multimodal open world data integration.

### BACKGROUND

Various embodiments of the present disclosure address technical challenges related to open world data integration. Through applied effort, ingenuity, and innovation many deficiencies of existing techniques and systems have been solved by developing solutions that are in accordance with the embodiments as discussed herein, many examples of which are described in detail herein.

### BRIEF SUMMARY

Various embodiments described herein relate to systems, apparatuses, methods, and computer program products for smart connected interface for multimodal open world data integration.

In accordance with one aspect of the present disclosure, a computer-implemented method is provided. In some embodiments, the computer-implemented method comprises receiving a command associated with a flight; generating, using a conversion model, an API request corresponding to the command based on an API schema associated with a connected API for one or more connected applications, wherein the API request comprises one or more flight parameters from the command mapped to a lexicon associated with the API schema; performing an impact assessment based on the API request to generate predicted impact data; generating a classification for the API request based on the predicted impact data; and initiating performance of one or more implementation actions based on the classification.

In some embodiments, the conversion model comprises a generative AI model.

In some embodiments, the command comprises a text command.

In some embodiments, the command comprises a voice command.

In some embodiments, generating the API request comprises parsing the command to extract the one or more flight parameters; and mapping the one or more flight parameters to one or more corresponding terms within the lexicon.

In some embodiments, the command comprises a requested change associated with the one or more flight parameters defined in a flight plan associated with the flight.

In some embodiments, generating the predicted impact data comprises applying the requested change to the flight plan and assessing impact of the requested change on one or more primary flight parameters.

In some embodiments, the one or more primary flight parameters comprise one or more of fuel consumption or estimated time of arrival.

In some embodiments, the performance of the one or more implementation actions comprises transmitting one or more computer-executable instructions configured to provide a modified flight plan to a flight management system.

In accordance with another aspect of the present disclosure, an apparatus is provided. The apparatus in some embodiments includes at least one processor and at least one memory storing instructions that, when executed by the at least one processor, cause the apparatus to receive a command associated with a flight; generate, using a conversion model, an API request corresponding to the command based on an API schema associated with a connected API for one or more connected applications, wherein the API request comprises one or more flight parameters from the command mapped to a lexicon associated with the API schema; perform an impact assessment based on the API request to generate predicted impact data; generate a classification for the API request based on the predicted impact data; and initiate performance of one or more implementation actions based on the classification.

In some embodiments, the conversion model comprises a generative AI model.

In some embodiments, the command comprises a text command.

In some embodiments, the command comprises a voice command.

In some embodiments, generating the API request comprises parsing the command to extract the one or more flight parameters; and mapping the one or more flight parameters to one or more corresponding terms within the lexicon.

In some embodiments, the command comprises a requested change associated with the one or more flight parameters defined in a flight plan associated with the flight.

In some embodiments, generating the predicted impact data comprises applying the requested change to the flight plan and assessing impact of the requested change on one or more primary flight parameters.

In some embodiments, the one or more primary flight parameters comprise one or more of fuel consumption or estimated time of arrival.

In some embodiments, the performance of the one or more implementation actions comprises transmitting one or more computer-executable instructions configured to provide a modified flight plan to a flight management system.

In accordance with another aspect of the present disclosure, a computer program product is provided. The computer program product in some embodiments includes at least one non-transitory computer-readable storage medium, the at least one non-transitory computer-readable storage medium having computer coded instructions configured to, when executed by at least one processor: receive a command associated with a flight; generate, using a conversion model, an API request corresponding to the command based on an API schema associated with a connected API for one or more connected applications, wherein the API request comprises one or more flight parameters from the command mapped to a lexicon associated with the API schema; perform an impact assessment based on the API request to generate predicted impact data; generate a classification for the API request based on the predicted impact data; and initiate performance of one or more implementation actions based on the classification.

In some embodiments, the conversion model comprises a generative AI model.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described the embodiments of the disclosure in general terms, reference now will be made to the accompanying drawings, which are not necessarily drawn to scale, and wherein:

FIGS. 1A-1B illustrate an example system environment within which embodiments of the present disclosure may operate.

FIG. 2 illustrates a block diagram of an example apparatus that may be specially configured in accordance with an example embodiment of the present disclosure.

FIG. 3 illustrates an example data flow diagram showing example data structures in accordance with at least one example embodiment of the present disclosure.

FIG. 4 illustrates operational examples of commands and API requests in accordance with at least one example embodiment of the present disclosure.

FIG. 5 illustrates an example flowchart depicting example process in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the present disclosure may be embodied in many different forms and should not be construed as limited to the embodiments set forth herein, rather, these embodiments are provided so that this disclosure will satisfy applicable legal requirements. The term “or” is used herein in both the alternative and conjunctive sense, unless otherwise indicated.

The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

It should be understood at the outset that although illustrative implementations of one or more aspects are illustrated below, the disclosed systems, apparatuses, methods, and computer program products may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements may be disclosed, the drawings may not be to scale.

### Overview and Technical Improvements

Various embodiments of the present disclosure address technical challenges related to open world data integration. Air traffic control (ATC) voice and controller pilot data link communications (CPDLC) text commands are fed to the avionics by the pilots. Some of the commands may be loadable to a flight management system (FMS) where the manual entry is not needed. Voice and free text commands may use different vocabulary and are completely pilot enterable. In this regard, existing solutions are error prone, impact of a modified scenario (e.g., cruise at FL350 from FL300) is not known before accepting the modification, and the requests may not be tailored per the existing state of avionics even if there is a room for optimization of flight parameters associated with the command.

Example embodiments of the present disclosure address the above challenges associated with existing solutions. Example embodiments retrieve a flight plan being flown and commands (e.g., ATC commands). Example embodiments, convert the commands to standard API schema for connected applications. Example embodiments, leverage a generative AI model to generate an API request (e.g., as the command may be of different vocabulary and/or accent). Based on the API schema associated with the connected application, the generative AI model retrieves a lexicon associated with the API schema, allows flight parameters in the command that are mapped to the lexicons and reject others. Example embodiments, based on the API request, visualizes the scenario and if acceptable sends the changes to the flight management system. If not acceptable, example embodiments, negotiate for an acceptable change.

In this regard, example embodiments of the present disclosure provide seamless integration of connected applications, adapt to standard API from multimodal commands (e.g., voice, free text, CPDLC loadable and non-loadable commands), automates “what if” scenarios based on API requests, handles variation in commands, and reduces pilot workload by sending the changes to the FMS.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “information,” and similar terms may be used interchangeably to refer to data capable of being transmitted, received, or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry or digital circuitry); (b) combinations of circuits and computer program product(s) comprising software or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, or the like. As a further example, as used herein, the term “circuitry” also includes an implementation comprising one or more processors or portion(s) thereof and accompanying software or firmware. As another example, the term “circuitry” as used herein also includes, for example, a baseband integrated circuit or applications processor integrated circuit for a mobile phone or a similar integrated circuit in a server, a cellular network device, other network device, or other computing device.

As used herein, a “computer-readable storage medium,” refers to a physical storage medium (e.g., volatile, or non-volatile memory device), and may be differentiated from a “computer-readable transmission medium,” which refers to an electromagnetic signal. A computer-readable storage medium may be a non-transitory medium.

As used herein, the terms “data structure,” “data object,” or “data set” refer interchangeably to data capable of being transmitted, received, or stored. For example, a predicted asset may be associated with one or more data elements or values in a computer-readable storage medium or computer-readable transmission medium, that represents content that is configured for use or display by one or more software applications, services, microservices, or the like.

As used herein, the terms “application,” “software application,” “app,” “computer program,” “service,” or similar terms refer to a computer program or group of computer programs designed to perform coordinated functions, tasks, or activities. Such computer programs may be operated by or for the benefit of a user or group of users. An application may be configured to provide access to one or more services provided by an entity. For example, an application may be configured to provide access to services provided by visual media content provider systems. An application may run on a server or group of servers, such as, but not limited to, web servers and application servers. In some embodiments, an application may be run on or across one or more other computing devices (e.g., user devices). For example, an application may be configured to be accessed via a web browser (e.g., a website accessed via the Internet using a browser), a dedicated client running on a user device, or the like. In some examples, an application may be configured for use by and interaction with one or more local, networked or remote computing devices.

The term “client computing device,” “client device” “client computing entity” and similar terms may be used interchangeably to refer to a computer comprising at least one processor and at least one memory. In some embodiments, the client computing device may further comprise one or more of: a display device for rendering one or more of a graphical user interface, a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” and the aforementioned similar terminology may refer to computer hardware or software that is configured to access a service or functionality offered by a system such as computing system 101 described herein, for example, a service or functionality that is made available by a server. Such a server may be in a different location or another computing system, in which case the client computing device may access the server by way of a network. Client computing devices may include, without limitation, smart phones, tablet computers, kiosk, terminal, laptop computers, wearables, personal computers, enterprise computers, or the like. In some examples, client computing devices, as described herein, may communicate with or otherwise access a computing system 101, via one or more networks.

In some embodiments, the at least one processor and the at least one memory need not be physically co-located with other elements of the client computing device (e.g., in a terminal environment, in which a display may be separated from a server-based processor or memory).

In some embodiments, a client computing device may be associated with a particular operator. For example, a client computing device may be operated by an operator (e.g., pilot, or the like) of an aircraft and embodied by a computer on the aircraft, pilot's computer, pilot's smartphone, or the like. In some embodiments, a client computing device may be a general purpose computing device having special purpose computer programming stored or executed thereon (e.g., a program, application, or web browser session running on a personal computer or smartphone). In some embodiments, a client computing device may be configured as a terminal or other remote viewing apparatus configured to display graphical user interfaces and associated information generated on a remote computing device. In some embodiments, a client computing device may be a special purpose computing device configured to perform the various functions described herein. Various embodiments of client computing devices may include, without limitation, smartphones, tablets, laptops, terminals, kiosks, personal computers, desktop computers, enterprise computers, or the like. Various embodiments of client computing devices may operate using different operating systems including, without limitation, IOS, ANDROID, WINDOWS, MACOS, LINUX, CHROME OS, or the like.

As used herein, the term “graphical user interface” refers to a representation of a software interface. For example, a graphical user interface may be the visual representation of a software such as a website, mobile application, desktop application, or the like, that may be used to generally interface with the software. By way of example, images, buttons, links, backgrounds, text fields, or the like, may be included within or make up a graphical user interface. In various examples, a graphical user interface may be configured for display on one or more screens (e.g., a screen of a mobile phone, a personal computer, or the like).

As used herein, the term “application programming interface” and “API” refers to a computing interface that defines indication inputs between applications, services, microservices, computing devices, repositories, or the like. An API may define formatting for one or more of a programming code call, request, function, procedure, notification, data object, data structure, or the like. Non-limiting examples of an application programming interface may include JavaScript Object Notation (JSON), Extensible Markup Language (XML), Simple Object Access Protocol (SOAP), Hypertext Markup Language (HTML), the like, or combinations thereof.

As used herein, the term “API request” refers to a structured communication sent to an API to request data or functionality. For example, the API request may be sent to an API associated with a computing system, computing device, or application, as described herein. In some examples, the API request may identify an application such as, for example, an application with respect to which the API request is intended. In some examples, the API request may be formatted according to a predefined schema, using, for example, a standard data interchange format such as JSON, XML, or the like.

As used herein, the term “repository,” “database,” and similar terms may be used interchangeably to refer to a computing location associated with a system where data is stored, accessed, modified, and otherwise maintained by the system. A repository may be used to store data in association with a data storage protocol or a query language. In certain embodiments, a repository may embody a data storage device or devices, a separate database server or servers, or as a combination of data storage devices and separate database servers. Further, in some embodiments, a repository may be embodied as a distributed repository such that some of the stored data is stored centrally in a location within the repository and other data stored in a single remote location or a plurality of remote locations. Alternatively, in some embodiments, a repository may be distributed over a plurality of remote storage locations only such as in a cloud storage environment.

As used herein, the term “machine learning model” refers to one or more processes, algorithms, or other data entity that describes parameters, hyper-parameters, defined operations, or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, deep neural networks, generative adversarial networks, convolutional neural networks, recurrent neural networks, large language models, generative pre-trained transformers (GPT), support vector machines, gradient boosts, decision trees, random forests, Markov models, adaptive Bayesian techniques, and statistical models (e.g., timeseries-based forecast models such as autoregressive models, autoregressive moving average models, or an autoregressive integrating moving average models). Additionally, and without limitation, an MDA, as used in the singular, may include ensembles using multiple machine learning or statistical techniques.

As used herein, the term “conversion model” refers to a model configured and/or trained to generate API requests, as described herein. The conversion model may include one or more of any type of machine learning models including one or more supervised, unsupervised, semi-supervised, reinforcement learning models, or the like. In some examples, the conversion model may comprise one or more artificial neural networks (e.g., deep neural networks). In some examples, the conversion model may comprise one or more decision trees algorithms or other machine learning algorithms. In some embodiments, the conversion model may be controlled, in part, by one or more predetermined configurations (e.g., via loading a configuration file) that define optimization parameters, goals, guardrails, or the like for directing or constraining the model output, which may further ensure reliability of the model performance. In some examples, the conversion model is a generative artificial intelligence (AI) model.

As used herein, the term “generative artificial intelligence model,” “generative AI model”, and similar terms may be used interchangeably to refer to one or more artificial intelligence models, including but not limited to some example machine learning models, configured to generate new outputs in response to a prompt or other input data. A generative AI model may include a large language model such as, for example, a generative pre-trained transformer (GPT) model.

As used herein the term “prompt” or “model prompt” refers to instructions or context provided to a generative AI model to guide the generative AI model's output generation. A prompt may serve as the starting point for interaction with the generative AI model, setting the stage for the type of output expected from the generative AI model or elicit an API request having a particular API schema from the generative AI model. The prompt may be a carefully engineered input to the generative AI model that encapsulates the specific requirements of an API/API schema for an application (e.g., connected application), as described herein. The prompt may be implemented as text that is sent to the generative AI model. For example, the prompt may be implemented as a string of text that is sent to the generative AI model via an API associated with the generative AI model.

As used herein the term “aircraft” refers to any machine, robot, computing devices, and/or apparatus comprised of hardware, software, firmware, and/or any combination thereof, that maneuvers throughout an environment through a medium, such as air. In some contexts, the aircraft is utilized to transport objects, entities (e.g., people, animals, or other beings), and/or other onboard cargo. In some situations, the aircraft may be transporting no object except for the aircraft itself. Examples of an aircraft include airplanes, helicopters, unmanned aerial vehicles (e.g., drones), vehicles configured to operate in an urban air mobility (UAM) environment, and/or the like. An aircraft is not limited to the examples listed herein and may include other types of transportation device. In some embodiments, the aircraft is configured to perform an aircraft mission (also referred to herein as a flight).

As used herein the terms “aircraft mission”, “aircraft flight”, or “flight” refer to a defined series of operations performed by the aircraft. For example, an aircraft mission/flight may include a defined series of operations performed by the aircraft to move from a first airport to a second airport. As another example, an aircraft mission/flight may include a defined series of operations performed by the aircraft to move from a home location (e.g., a docking station of a UAV) to a destination (e.g., a package drop off location) and/or from a destination location to a home location. In this regard, in some embodiments, an aircraft mission/flight may comprise the aircraft performing preflight procedures, (e.g., at the gate before a flight, at a home location of a UAV, etc.), leaving a gate or home location, taxiing, taking off (e.g., a visual-assisted automatic landing), climbing, cruising (e.g., a cruise phase between takeoff and landing where the aircraft is at a cruise altitude), descending, landing (e.g., a visual-assisted automatic landing), parking at a gate or a destination location, performing post flight procedures (e.g., at the gate after a flight, at a destination location, etc.), and/or the like. For example, an aircraft mission may include a defined series of operations that includes leaving the gate at a first airport or a docking station at a home location, taxiing to a runway at the first airport (e.g., an originating airport), taking off from the first airport or the home location, climbing (e.g., to a cruising altitude), flying (e.g., at a cruise altitude) to a second airport (e.g., a destination airport) or a destination location, descending (e.g., from a cruising altitude), landing at the second airport or a destination location, taxiing to a gate at the second airport or a destination location, and/or parking at a gate at the second airport or at a destination location.

### Example System, Apparatuses, and Data Flow

Various embodiments of the present disclosure may be implemented as methods, apparatus, systems, computing devices, computer program products, or the like. As such, embodiments of the present disclosure may take the form of an apparatus, system, computing device, computing entity, or the like executing instructions stored on a computer-readable storage medium to perform certain steps or operations. Thus, embodiments of the present disclosure may take the form of an entirely hardware embodiment, an entirely computer program product embodiment, or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, or apparatus, systems, computing devices, computing devices, or the like carrying out instructions, operations, steps, and similar words used interchangeably (e.g., the executable instructions, instructions for execution, program code, or the like) on a computer-readable storage medium for execution. For example, retrieval, loading, and execution of code may be performed sequentially such that one instruction is retrieved, loaded, and executed at a time. In some example embodiments, retrieval, loading, or execution may be performed in parallel such that multiple instructions are retrieved, loaded, or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

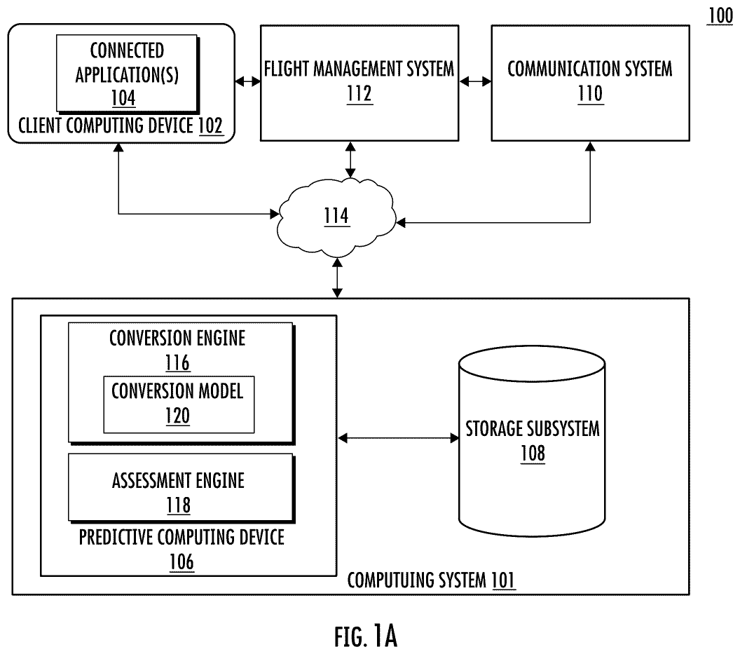

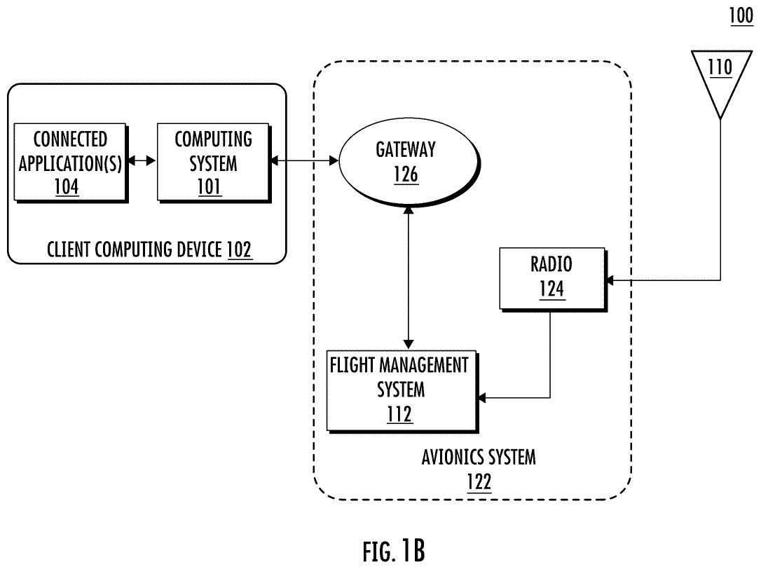

In this regard, FIG. 1A shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1A and the system environment 100 disclosed therein is merely presented to provide an example basis and context for the facilitation of some of the features, aspects, and uses of the methods, apparatuses, computer readable media, and computer program products disclosed and contemplated herein.

The system environment 100 comprises a computing system 101 configured to support multimodal open world data integration in accordance with at least one example embodiment of the present disclosure. For example, the computing system 101 may provide and/or represent a smart connected interface configured to support multimodal open world data integration in accordance with at least one example embodiment of the present disclosure. In some embodiments, the computing system 101 is configured to receive commands of various types, including but not limited to voice commands and text commands, and convert the received command to a standard API schema for one or more connected applications 104, as described herein. For example, the computing system 101 may be configured to generate an API request corresponding to the received command based on an API schema associated with a connected API for the one or more connected applications 104, such that the API request is in accordance with the API schema associated with the connected API. Non-limiting examples of such connected APIs include flight plan update request API, flight plan fetch API, and/or the like. In some embodiments, the computing system 101 leverages a conversion model 120, as described herein, to generate the API request. In some embodiments, the conversion model 120 is an artificial intelligence (AI) model such as, for example, a generative AI model.

In some embodiments, the computing system 101 is configured to initiate and/or perform impact assessment based on the API request to generate predicted impact data. In some embodiments, the computing system 101 is configured to generate a classification (e.g., reject or accept) for the API request based on the predicted impact data, and initiate the performance of one or more implementation actions based on the classification. The example system environment 100 may be used in a plurality of domains and not limited to any specific application as disclosed herewith. In some embodiments, the computing system 101 may be utilized onboard a mobile platform such as, for example, an aircraft equipped with or otherwise associated with the computing system 101.

The computing system 101 may be configured to communicate with one or more of a client computing device 102, communication system 110, and/or a flight management system 112 using one or more communication networks, such as communication network 114. Examples of communication networks comprise any wired or wireless communication network including, for example, a wired or wireless local area network (LAN), personal area network (PAN), metropolitan area network (MAN), wide area network (WAN), or the like, as well as any hardware, software, or firmware required to implement it (such as, e.g., network routers, or the like).

In some embodiments, the computing system 101 may be separate from or integrated within the flight management system 112. In some embodiments, two or more of the computing system 101, the client computing device 102, the communication system 110, and/or the flight management system 112 may be part of a larger system (e.g., an aircraft system or flight control system). In some embodiments, the computing system 101 may be embodied by the client computing device 102. For example, as shown in FIG. 1B, in some embodiments, the computing system 101 may be a part of the client computing device 102 and configured to provide seamless integration of the air traffic control commands with connected applications 104 hosted by, or otherwise associated with, the client computing device 102.

In some embodiments, the computing system 101 comprises a predictive computing device 106 configured via hardware, software, and/or firmware to perform various functions of the computing system 101. In some embodiments, a computing device, such as a predictive computing device 106 may comprise one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, or any combination of devices or entities adapted to perform the functions, operations, or processes described herein. Such functions, operations, or processes may comprise, for example, transmitting, receiving, operating on, processing, displaying, storing, determining, creating/generating, training one or more machine learning models or generative AI models, monitoring, evaluating, comparing, or similar terms used herein interchangeably. In some embodiments, these functions, operations, or processes may be performed on data, content, information, or similar terms used herein interchangeably.

The predictive computing device 106 may comprise or otherwise may be associated with a storage subsystem 108 that may be configured to store input data, training data, or the like that may be used by the predictive computing device 106 to perform predictive data analysis or training operations of the present disclosure. In addition, the storage subsystem 108 may be configured to store model definition data used by the predictive computing devices 106 to perform various predictive data processing or training tasks. The storage subsystem 108 may comprise one or more storage units, such as multiple distributed storage units that are connected through a computer network. A storage unit in the storage subsystem 108 may store at least one of one or more data assets or a set of data about the computed properties of one or more data assets. Moreover, each storage unit in the storage subsystem 108 may comprise one or more non-volatile storage or volatile storage media similar to or different than the non-volatile or volatile computer-readable storage media discussed above.

The predictive computing device 106 may be configured according to the techniques described herein to perform one or more operations of one or more techniques described herein. In some examples, the predictive computing device 106 may be configured to train, implement, use (e.g., execute an inference operation(s)), update (e.g., fine-tune), and evaluate machine learning models/AI models (e.g., conversion models) in accordance with one or more training or inference operations of the present disclosure.

In some example embodiments, the predictive computing device 106 may be configured to receive or transmit one or more datasets, objects, or the like from or to the client computing device 102 and/or flight management system 112 to perform one or more steps/operations of one or more techniques (e.g., data conversion techniques, predictive data analysis techniques) described herein. The client computing device 102 and/or flight management system 112, for example, may comprise or be associated with one or more devices that may be configured to receive, transmit, store, manage, or facilitate datasets, or the like. The client computing device 102 and/or flight management system 112, for example, may comprise data sources that may provide such datasets, or the like to the predictive computing device 106 which may leverage the datasets, such as altitude data, vertical rate data, wind data, environmental data aircraft weight, aircraft configuration data, model data, training data, or the like to perform one or more steps/operations of the present disclosure, as described herein. For example, such datasets may be leveraged by the predictive computing device 106 to facilitate and/or perform impact assessment in accordance with at least one example embodiment of the present disclosure. In some examples, the datasets received from the client computing device 102 and/or the flight management system 112 may be stored in one or more databases of a storage subsystem 108 associated with the predictive computing device 106.

In some example embodiments, the predictive computing device 106 includes a conversion engine 116 and an assessment engine 118. The conversion engine 116 may be configured via hardware, software, and/or firmware to perform one or more steps/operations of the present disclosure, including generating API requests, as described herein. The conversion engine 116 may include one or more conversion models 120 trained and/or configured convert a command, such as ATC command, to standard API schema (e.g., generate an API request corresponding to the command in accordance with an API schema associated with a connected API for one or more connected applications 104).

The assessment engine 118 may be configured via hardware, software, and/or firmware to perform one or mor steps/operations of the present disclosure, including initiating and/or performing impact assessment to generate predicted impact data, as described herein. In some embodiments, performing such impact assessment may comprise utilizing various techniques as described herein, including, but not limited to, predictive data analysis techniques, what if scenario techniques, simulation techniques, analytical techniques, machine learning techniques, and/or the like.

The client computing device 102 may include computer hardware or software configured to perform one or more functionalities associated with the client computing device 102. In some embodiments, the client computing device 102 may be a mobile device. For example, the client computing device 102 may be a mobile device that is capable of being held and transported by an operator. Example mobile devices include, but not limited to, smart phones, tablet computers, laptop computers, wearables, laptop computers, elements or devices interacting with such devices (e.g., web cams, microphones, etc.), or the like. By way of example, the client computing device 102 may represent an electronic flight bag (EFB) in some implementations. In some embodiments, the client computing device 102 may be a device owned by or otherwise assigned to the operator (e.g., a personal mobile phone, tablet, laptop, desktop computer, elements or other related devices, etc.). In some embodiments, the client computing device 102 is an electronic computing device that may be used by an operator for any of a variety of purposes including, but not limited to, one or more of sending or receiving signals, storing data, displaying data, viewing data, transmitting data, receiving data, or the like. For example, the client computing device 102 may be capable of, but not limited to, one or more of displaying graphical user interfaces and other graphical representations on the screens of the client computing device 102, receiving operator input, and/or the like.

The client computing device 102 may use (e.g., access or install) one or more computer program products (e.g., a mobile application platform, desktop computer application platform) configured to provide one or more functionalities of the client computing device. In some embodiments, the client computing device 102 hosts or is otherwise associated with one or more connected applications 104. In some embodiments, a connected application 104 is a software application configured to provide or more functionalities associated with a flight including, but not limited to, flight planning. For example, in some embodiments, the one or more connected applications 104 may comprise one or more flight planning applications configured for generating flight plans and/or providing other functionalities associated with flight planning for a flight, including real-time modification of flight plan during the flight. For example, a client computing device 102 may host one or more connected applications (e.g., one or more flight planning applications) that allow flight crews to perform various functions such as flight planning calculations, displaying navigation charts, displaying real-time weather information, and/or the like.

In some embodiments, the client computing device 102 may include a display component on which a graphical user interface may be rendered. In some embodiments, the predictive computing device 106 may be configured to transmit computer executable instructions configured to cause a graphical user interface to be rendered on the display component of the client computing device. For example, the predictive computing device 106 may be configured to command and/or control the client computing device 102 to generate a graphical user interface that includes a variety of GUI objects or elements (e.g., buttons, sliders, and the like) which may be used to prompt a user (e.g., pilot of other flight crew) to interact with the predictive computing device 106 to provide user input, and for the predictive computing device 106 to activate corresponding functions and provide user feedback, responsive to received user input at the graphical user interface element. In some embodiments, the display component may be a touch screen display.

In some embodiments, the communication system 110 may be configured for transmitting communications, including commands, from air traffic control (ATC) to an aircraft. In some embodiments, the communication system 110 is a two-way data-link communication system such as a controller pilot data link communications (CPDLC) system. In some embodiments, the communication system 110 may be configured to facilitate voice communications and text communications. For example, the communication system 110 may be configured to receive voice commands and/or text commands from air traffic control and transmit the voice commands and/or text commands, directly or indirectly, to the computing system 101.

In some embodiments, the flight management system 112 is configured via hardware, software, and/or firmware to provide various flight management functionalities, including generating flight plans. The flight management system 112 may include various flight-related functions including, but not limited to, flight planning, navigation, flight optimization, and/or the like. The flight management system 112 may be configured to receive or otherwise ingest data (e.g., flight plan data, navigation data, environmental data (e.g., temperature, wind data, and/or the like) from various avionics components, flight crew (e.g., pilot), and/or air traffic control. The flight management system 112 may be configured to leverage the data to provide various flight management functionalities, as described herein.

In some embodiments, as shown in FIG. 1B, the flight management system 112 may be part of an avionics system 122. The avionics system 122 may include various components including, but not limited to the flight management system 112, a radio 124, and a gateway 126. In some embodiments, the communication system 110 may be communicatively coupled to the radio 124 to facilitate transmission of commands from air traffic control. In some embodiments, the flight management system 112 may be communicatively coupled to a gateway 126. In some embodiments, the computing system 101 may be communicatively coupled to the gateway 126. In this regard, in some embodiments, the gateway 126 may be configured to facilitate communication between the computing system 101 and the flight management system 112. For example, the gateway 126 may be configured via hardware, software, and/or firmware to facilitate exchange of data between the computing system 101 and the flight management system 112.

It will be understood that while many of the aspects and elements presented in FIG. 1A are shown as discrete, separate elements, other configurations may be used in connection with the methods, apparatuses, computer readable media, and computer programs described herein, including configurations that combine, omit, separate, or add aspects or elements. The various functions of the system environment 100 may be performed by other arrangements of one or more computing devices or computing systems without departing from the scope of the present disclosure. For example, in some embodiments, the functions of one or more of the illustrated elements in FIG. 1A may be performed by a single computing device or by multiple computing devices, which devices may be local or cloud based.

It will be appreciated that the various functions performed by two or more of the computing system 101, client computing device 102, communication system, or flight management system 112 may be embodied by a single apparatus, subsystem, or system comprising one or more sets of computing hardware (e.g., processor(s) and memory) configured to perform various functions thereof. In some embodiments, one or more intermediary devices may be positioned in electrical communication between the depicted system elements (e.g., connection between computing devices may be facilitated by various intermediary networking hardware or software elements). In some embodiments, two or more of the depicted computing devices or systems may be part of a single system or device. In some embodiments, two or more of the depicted devices or computing systems may be physically or electronically remote from each other (e.g., connected via the Internet).

The various elements illustrated in the system environment 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software or firmware required to implement it (such as, e.g., network routers, etc.). For example, the network may include a cellular telephone, an 802.11, 802.16, 802.20, or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the elements depicted in FIG. 1A and/or FIG. 1B as being included in the computing system 101, the communication system 110, the flight management system 112, the predictive computing device 106, or the client computing device 102, although not required to be an integral system, may be connected via one or more networks. In some embodiments, one or more APIs may be leveraged to communicate with or facilitate communication between one or more of the elements illustrated in the computing system 101 and system environment 100.

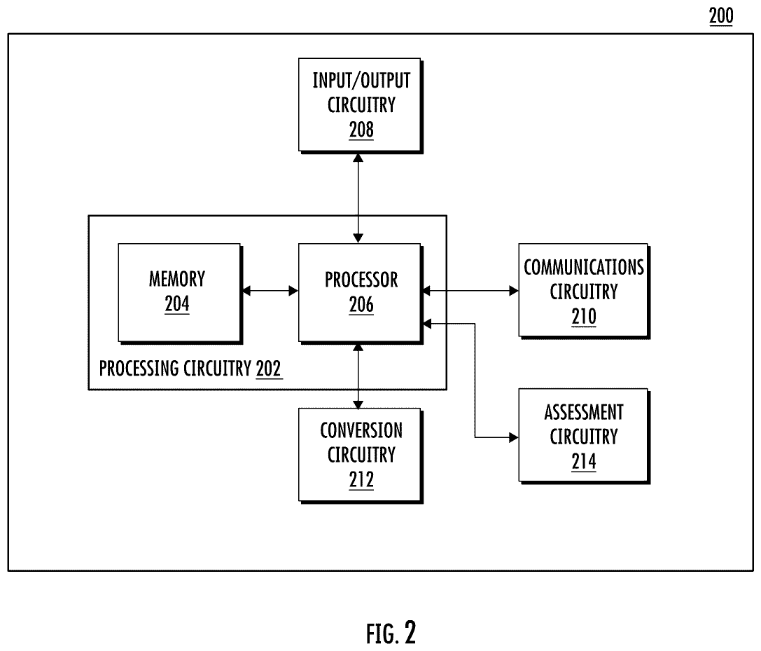

Now referencing FIG. 2, a block diagram of an apparatus 200 in accordance with at least one example embodiment of the present disclosure is provided. For example, in some embodiments, the computing system 101 may be embodied by one or more apparatuses 200. In this regard, in some embodiments, the computing system 101 or one or more portions (e.g., one or more individual elements) thereof, if embodied in a particular embodiment, may be embodied by one or more apparatuses 200.

In some embodiments, the apparatus 200 may include a processing circuitry 202 as shown in FIG. 2. In some embodiments, the elements illustrated in and described with reference to FIG. 2 below may not be mandatory and thus one or more may be omitted in certain embodiments. Additionally, some embodiments may include further or different elements beyond those illustrated in and described with reference to FIG. 2. In some embodiments, the functionality of the computing system 101 or any subset thereof may be performed by a single apparatus 200 or multiple apparatuses 200. In some embodiments, the apparatus 200 may comprise one or a plurality of physical devices, including distributed, cloud-based, or local devices.

Although some elements are described with respect to functional limitations, it should be understood that the particular implementations necessarily include the use of particular computing hardware, such as the hardware shown in FIG. 2. It should also be understood that certain of the elements described herein may include similar or common hardware. For example, two sets of circuitries for example, may both leverage use of the same processor(s), network interface(s), storage medium(s), or the like, to perform their associated functions, such that duplicate hardware is not required for each set of circuitry and a single physical circuitry may be used to perform the functions of multiple circuitries described herein. The use of the term “circuitry” as used herein with respect to elements of the apparatuses described herein should therefore be understood to include particular hardware configured to perform the functions associated with the particular circuitry as described herein.

In some embodiments, “circuitry” may include processing circuitry, storage media, network interfaces, input/output devices, or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, or the like.

The apparatus 200 may include or otherwise be in communication with processing circuitry 202 that is configurable to perform actions in accordance with one or more example embodiments disclosed herein. In this regard, the processing circuitry 202 may be configured to perform or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, or other processing and management services according to one or more example embodiments. In some embodiments, the apparatus 200 or a portion(s) or elements(s) thereof, such as the processing circuitry 202, may be embodied as or comprise a chip or chip set. In other words, apparatus 200 or the processing circuitry 202 may comprise one or more physical packages (e.g., chips) including materials, elements or wires on a structural assembly (e.g., a baseboard). The structural assembly may provide physical strength, conservation of size, or limitation of electrical interaction for element circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry-in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, or one or more remote or “cloud” processor(s) external to the apparatus 200.

In some example embodiments, the memory 204 may include one or more non-transitory memory devices such as, for example, volatile or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions or the like for enabling the apparatus 200 to carry out various functions in accordance with one or more example embodiments. For example, the memory 204 may be configured to buffer input data for processing by the processor 206. Additionally, or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, input/output circuitry 208 or communications circuitry 210, via a bus(es) for passing information among elements of the apparatus 200.

The input/output circuitry 208 may provide output to the user or an intermediary device and, in some embodiments, may receive one or more indication(s) of user input directly or indirectly. In some embodiments, the input/output circuitry 208 is in communication with processor 206 to provide such functionality. The input/output circuitry 208 may include one or more user interface(s) or include a display that may comprise the user interface(s) rendered as a web user interface, an application interface, or the like, to the display of a client computing device, a backend system, or the like. The input/output circuitry 208 may be in communication with the processing circuitry 202 to receive an indication of a user input at the user interface or to provide an audible, visual, mechanical, or other output to the user. As such, the input/output circuitry 208 may include, for example, a keyboard, a mouse, a joystick, a display, a touch screen display, a microphone, a speaker, or other input/output mechanisms. As such, the input/output circuitry 208 may, in some example embodiments, provide means for a user to access and interact with the apparatus 200. The processor 206 or input/output circuitry 208 comprising or otherwise interacting with the processor 206 may be configured to control one or more functions of one or more user interface elements through computer program instructions (e.g., software or firmware) stored on a memory accessible to the processor 206 (e.g., stored on memory 204, or the like).

The communications circuitry 210 may include one or more interface mechanisms for enabling communication with other devices or networks. In some cases, the communications circuitry 210 may comprise any means such as a device or circuitry embodied in either hardware, or a combination of hardware and software that is configured to receive or transmit data from/to a network or any other device or module in communication with the processing circuitry 202. The communications circuitry 210 may, for example, include an antenna (or multiple antennas) and supporting hardware or software for enabling communications with a wireless communication network (e.g., a wireless local area network, cellular network, global positioning system network, or the like) or a communication modem or other hardware/software for supporting communication via cable, digital subscriber line (DSL), universal serial bus (USB), Ethernet or other methods.

In some embodiments, the apparatus 200 may include a conversion circuitry 212 which may include hardware elements, with or without enabling software elements, firmware elements, or a combination thereof configured to, with the processing circuitry 202, input/output circuitry 208 or communications circuitry 210, perform one or more functions associated with the predictive computing device 106 (as described above with reference to FIG. 1A), particularly the conversion engine 116 thereof. For example, the conversion circuitry 212 may access, facilitate access, receive, process, manipulate, provide, or otherwise use, or make available for use, certain data used by one or more other elements of the apparatus 200 through, for example, the use of hardware, software, applications, or APIs executed using a processor, such as the processor 206. In some embodiments, the conversion circuitry 212 may interact with the memory 204, which may store the aforementioned data. It should also be appreciated that, in some embodiments, the conversion circuitry 212 may include a separate processor, specially configured field programmable gate array (FPGA), or application specific interface circuit (ASIC) to receive such data utilized by the conversion circuitry 212. The conversion circuitry 212 may also provide for communication with other elements of the apparatus 200, system or external systems via a network interface provided by the communications circuitry 210. In some embodiments, one or more portions of the conversion circuitry 212 and processing circuitry 202 may be integrated into a single circuitry or group of circuitries, with or without various other circuitries discussed herein, configured to execute the respective functionalities thereof.

In some embodiments, the apparatus 200 may include an assessment circuitry 214 which may include hardware elements, with or without enabling software elements, firmware elements, or a combination thereof configured to, with the processing circuitry 202, input/output circuitry 208 or communications circuitry 210, perform one or more functions associated with the predictive computing device 106 (as described above with reference to FIG. 1A), particularly the assessment engine 118 thereof. For example, the assessment circuitry 214 may access, facilitate access, receive, process, manipulate, provide, or otherwise use, or make available for use, certain data (e.g., altitude data, vertical data, wind data, or other data) used by one or more other elements of the apparatus 200 through, for example, the use of hardware, software, applications, or APIs executed using a processor, such as the processor 206. In some embodiments, the assessment circuitry 214 may interact with the memory 204, which may store the aforementioned data. It should also be appreciated that, in some embodiments, the assessment circuitry 214 may include a separate processor, specially configured field programmable gate array (FPGA), or application specific interface circuit (ASIC) to receive such data utilized by the assessment circuitry 214. The assessment circuitry 214 may also provide for communication with other elements of the apparatus 200, system or external systems via a network interface provided by the communications circuitry 210. In some embodiments, one or more portions of the assessment circuitry 214 and processing circuitry 202 may be integrated into a single circuitry or group of circuitries, with or without various other circuitries discussed herein, configured to execute the respective functionalities thereof.

In this regard, FIG. 1A-B shows an example system environment 100 within which at least some embodiments of the present disclosure, including apparatus(es) 200, may operate. The depictions of the example system environment 100 and apparatus 200 are not intended to limit or otherwise confine the embodiments described and contemplated herein to any particular configuration of elements or systems, nor are they intended to exclude any alternative configurations or systems for the set of configurations and systems that can be used in connection with embodiments of the present disclosure. Rather, FIGS. 1A-B, and FIG. 2 and the system environment 100 and apparatus(es) 200 disclosed therein are merely presented to provide an example basis and context for the facilitation of some of the features, aspects, and uses of the methods, apparatuses, computer readable media, and computer program products disclosed and contemplated herein.

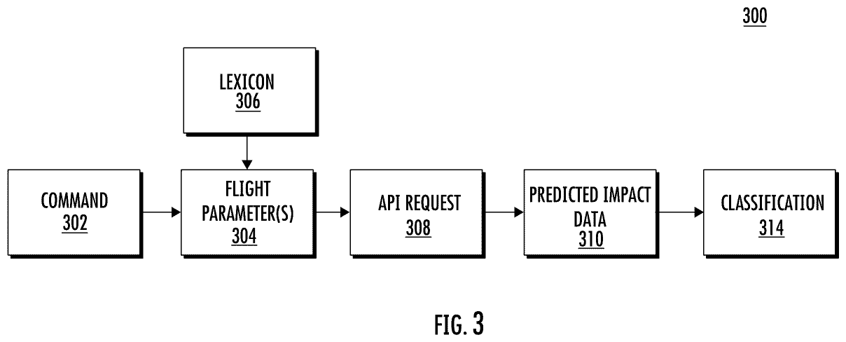

Now referencing FIG. 3, an example data flow 300 presented in accordance with at least one example embodiment of the present disclosure is provided. In some example embodiments, the data structures and processes shown and described with reference to the data flow diagram of FIG. 3 may be generated, performed, or otherwise facilitated by the various systems and apparatuses shown and described with reference to FIGS. 1A-B and FIG. 2.

In some embodiments, the computing system 101 (e.g., conversion engine 116 of the predictive computing device 106 thereof) receives a command 302 associated with a flight. In some embodiments, the command 302 comprises a request to modify a flight plan.

In some embodiments, a flight plan comprises data indicative and/or representative of a planned route (e.g., flight path) for a flight. In some embodiments, the flight plan may comprise an initial flight plan generated by a flight management system 112. The flight plan may be generated prior to the flight (e.g., prior to aircraft departure). For example, a flight plan may be generated for a planned flight and may comprise data indicative and/or representative of a planned route for the flight. A flight plan may comprise various data including data for one or more flight parameters (e.g., altitude, cruise speed, climb, takeoff, descent, and/or the like) calculated for the flight. For example, a flight plan may include altitude data, cruise speed data, and/or the like for the flight. In some embodiments, the one or more flight parameters may comprise variable data. For example, in such some embodiments, the flight parameter data (e.g., altitude data, cruise speed, and/or the like) may be modified during the flight. A flight plan may include other data such as aircraft identifier, flight rules, flight type, aircraft type, departure aerodrome, departure time, and/or the like.

In this regard, in some embodiments, a request to modify a flight plan comprises a request to modify one or more flight parameters defined in the flight plan (e.g., initial flight plan or current flight plan). For example, in some embodiments, the command 302 comprises a requested change to one or more flight parameters defined in a flight plan. In this regard, in some embodiments, the command 302 may comprise at least one flight parameter, where the command 302 may comprise a request to change or otherwise modify the at least one flight parameter. By way of example, an example command 302 may comprise a request to change altitude data and/or cruise speed during a flight.

In some embodiments the command 302 comprises a voice command or a text command. In some embodiments, the command 302 may be received from communication system 110, such as CPDLC system configured to support voice communication and/or text communication (e.g., text messages) from a controller such as air traffic control (ATC). In this regard, in some embodiments, the command 302 may originate from an air traffic control (ATC) and transmitted via a CPDLC system, directly or indirectly, to the computing system 101.

In some embodiments, the computing system 101 (e.g., conversion engine 116 of the predictive computing device 106 thereof) generates, using a conversion model 120, an API request 308 corresponding to the command 302. For example, the API request 308 may comprise a message indicative and/or representative of a request to a connected application for a service, functionality, or data. In some embodiments generating the API request 308, using the conversion model 120, comprises configuring the computing system 101 to autonomously input the command 302 into the conversion model 120 to receive an API request 308 corresponding to the command 302 in response to receiving the command 302.

In some embodiments, the conversion model 120 is configured and/or trained to generate the API request 308 based on an API schema associated with a connected API for one or more connected applications 104 hosted by or otherwise associated with the client computing device 102. For example, the API request 308 may have an API schema that corresponds to the API schema associated with a connected API. The API schema may define a structure and/or data types of the API request 308. In this regard, the computing system 101, using the conversion model 120, may generate an API request 308 in accordance with an API schema associated with connected API(s) for one or more connected applications to facilitate seamless exchange of data between the communication system 110 (e.g., commands transmitted via the communication system 110), and the one or more connected applications 104 (e.g., open world applications). In some embodiments, the conversion model 120 is a generative AI model configured to trained and/or the like to receive a prompt comprising the command 302 and output an API request 308 corresponding to the command.

In some embodiments, generating the API request 308 based on the API schema comprises identifying a lexicon 306 associated with the API schema, and mapping the command 302 (e.g., one or more flight parameters 304 thereof) to the lexicon 306. In some embodiments, the lexicon 306 associated with the API schema comprises a plurality of terms recognized by the connected application(s) or otherwise defined within the connected application(s). In some embodiments, the conversion model 120 is configured to retrieve the lexicon 306 from one or more databases.

In some embodiments, generating the API request 308 comprises parsing the command 302 to extract one or more flight parameters 304 from the command 302, and mapping at least a subset of the one or more flight parameters 304 to corresponding terms in the lexicon 306. In this regard, the API request 308 may comprise each flight parameter from the one or more flight parameters 304 that is mapped by the conversion model 120 to a corresponding term in the lexicon 306. For example, where the one or more flight parameters 304 comprise cruise altitude parameter and the lexicon 306 also includes cruise altitude, the conversion model 120 may be configured to generate an API request 308 that includes the cruise altitude parameter. As another example, where the one or more flight parameters 304 comprise cruise altitude parameter and the lexicon 306 does not include cruise altitude, the conversion model 120 may be configured to generate an API request that omits the cruise altitude parameter. In some embodiments, the conversion model 120 may be configured to generate an output that does not include an API request in response to determining that at least one of the one or more flight parameters 304 does not correspond to any of the terms in the lexicon 306. In some embodiments, the conversion model 120 may be configured to generate an output that does not include an API request in response to determining that none of the one or more flight parameters 304 correspond to any of the terms in the lexicon 306. For example, such output may comprise data that describes that the command includes one or more flight parameters that is not recognized in the connected application(s) 104.

In some embodiments, the computing system 101 (e.g., assessment engine 118 of the predictive computing device 106 thereof) facilitates and/or performs an impact assessment based on the API request 308 to generate predicted impact data 310. In some embodiments, the predicted impact data 310 is indicative and/or representative of predicted impact of the requested change defined in the API request 308 (e.g., corresponding command 302) on one or more primary flight parameters (e.g., fuel consumption, aircraft speed, estimated time of arrival, and/or the like) if implemented. In this regard, in some embodiments, the predicted impact data 310 may comprise data indicative and/or representative of the predicted impact of the requested change on each of at least one of the one or more primary flight parameters.

In some embodiments, facilitating and/or performing an impact assessment based on the API request 308 comprises configuring the computing system 101 to direct and/or control the one or more connected applications 104 to perform an impact assessment based on the API request. For example, in some embodiments, the computing system 101 may transmit the API request 308 to one or more connected applications 104 to receive the predicted impact data 310.

In some embodiment, facilitating and/or performing an impact assessment based on the API request 308 comprises configuring the computing system 101 to leverage data received from the one or more connected applications 104 to perform the impact assessment. For example, in some embodiments, the computing system 101 may transmit the API request 308 to one or more connected applications 104 to receive various flight data (including current state of the aircraft) from the one or more connected applications 104, and perform a predictive data analysis task based on the received flight data to generate the predicted impact data 310.

In some embodiments, performing the impact assessment comprises applying the requested change to the flight plan to generate a modified flight plan, and analyzing the modified flight plan to generate the predicted impact data 310. For example, the computing system 101 may identify and/or detect the current aircraft state and apply the requested change to the flight plan with respect to the current aircraft state to generate a modified flight plan and a predicted impact data 310. In some embodiments, performing the impact assessment may comprise applying one or more machine learning techniques. In some embodiments, performing the impact assessment may comprise performing what-if-scenarios task.

In some embodiments, the computing system 101 generates a classification 314 for the API request based on the predicted impact data. In some embodiments, the classification 314 is indicative and/or representative of acceptance or rejection of the predicted impact of implementation of the requested change. For example, in some embodiments, the computing system 101 may be configured to generate an accept classification or a reject classification for the API request based on the predicted impact data 310. In this regard, the computing system 101 may accept or reject the command 302 corresponding the API request 308 based on the classification 314.

In some embodiments, the computing system 101 initiates the performance of one or more implementation actions based on the classification 314. In some embodiments, the performance of the one or more implementation actions comprises transmitting the requested change reflected in the command 302 to the flight management system 112 in response to an accept classification. In some embodiments, the performance of the one or more implementation actions comprises transmitting a modified flight plan (e.g., based on the requested change) to the flight management system 112 in response to an accept classification.

In some embodiments, the performance of the one or more implementation actions comprises transmitting a modified requested change to the flight management system 112 in response to a reject classification. In this regard, the computing system 101 may be configured to negotiate an acceptable change in response to a reject classification.

In some embodiments, the performance of the one or more implementation actions comprises rendering a graphical user interface comprising a modified flight plan or alert on a display of the client computing device 102.

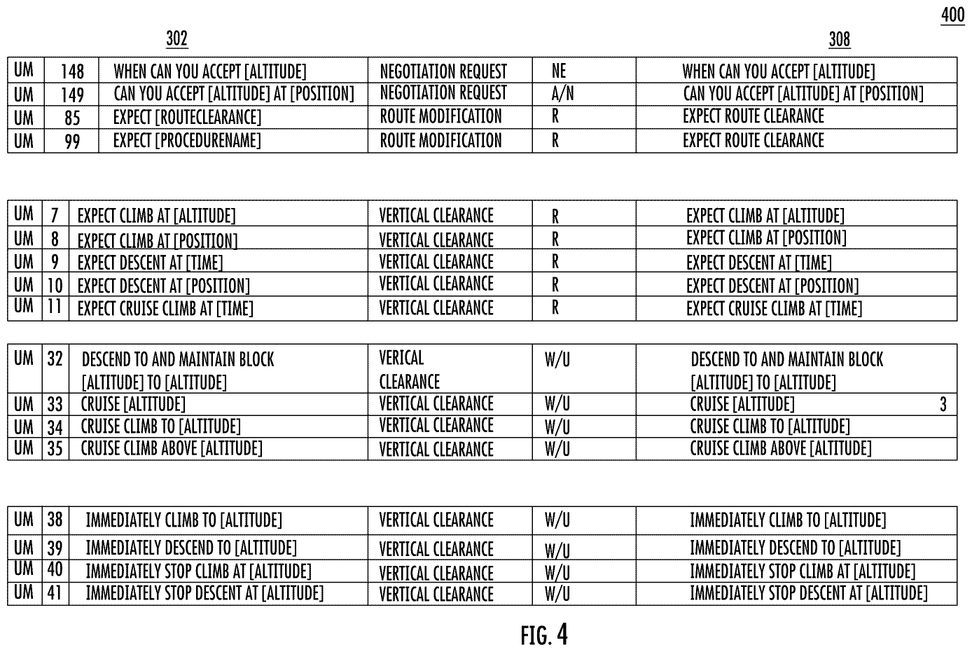

Now referencing FIG. 4 an operation example 400 of commands 302 and corresponding API request 308 (e.g., at least a portion of the message within the API request 308) is provided. As shown in FIG. 4, a command 302 and corresponding API request 308 may comprise one or more flight parameters (e.g., cruise altitude, climb, descent, cruise climb, and/or the like).

### Example Methods

Having described example systems, apparatuses, and data flow in accordance with the present disclosure, example processes in accordance with at least one example embodiment of the present disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

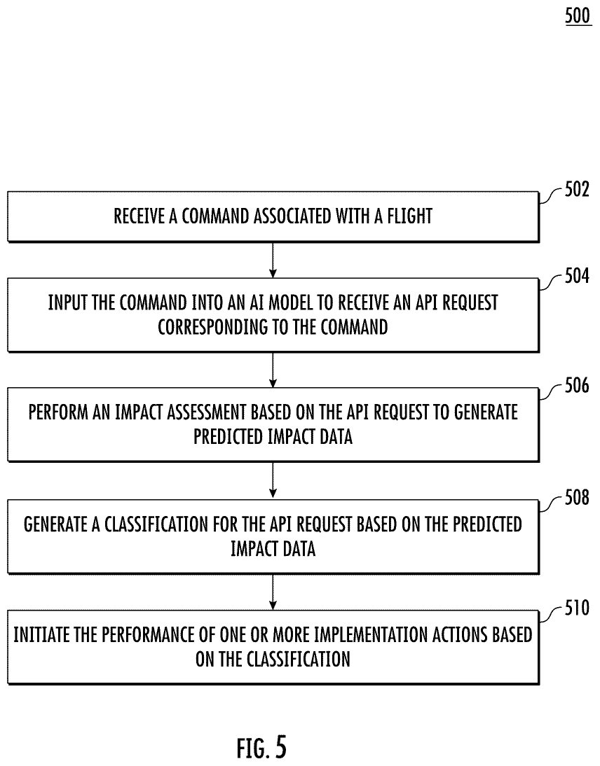

FIG. 5 illustrates an example computer-implemented process 500 in accordance with at least one embodiment of the present disclosure. The process 500 may be implemented by one or more computing devices, entities, or systems described herein.

In some embodiments, the process 500 is embodied by computer program code stored on a non-transitory computer-readable storage medium of a computer program product configured for execution to perform the process as depicted and described. Alternatively, or additionally, in some embodiments, the process 500 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. For purposes of simplifying the description, the process 500 is described as performed by and from the perspective of the apparatus 200.

In some embodiments, the process 500 comprise at operation 502, receiving a command associated with a mission. In some embodiments, the command is received from a communication system such as a CPDLC system. For example, the command may originate from an ATC and transmitted using a CPDLC. In some embodiments, the command is a voice command. In some embodiments, the command is a text command.

In some embodiments, the process 500 comprise at operation 504, inputting the command into a conversion model to receive an API request corresponding to the command. In some embodiments, the conversion model is a generative AI model. For example, the apparatus 200 may generate, using a conversion model, an API request corresponding to the command based on an API schema associated with a connected API for one or more connected applications.

In some embodiments, the process 500 comprise at operation 506, performing an impact assessment based on the API request to generate predicted impact data. For example, the apparatus 200 direct and/or control the one or more connected applications 104 to perform an impact assessment based on the API request. For example, the apparatus 200 may transmit the API request to one or more connected applications to receive the predicted impact data.

In some embodiment, performing an impact assessment based on the API request comprises transmitting the API request 308 to one or more connected applications to receive various flight data (e.g., including current state of the aircraft) from the one or more connected applications, and performing a predictive data analysis task based on the received flight data to generate the predicted impact data. In some examples, performing the impact assessment comprises applying the requested change reflected in the API request to the flight plan associated with the flight to generate a modified flight plan, and analyzing the modified flight plan to generate the predicted assessment data. For example, the apparatus 200 may identify and/or detect the current aircraft state and apply the requested change to the flight plan with respect to the current aircraft state to generate a modified flight plan and a predicted impact data. In some embodiments, performing the impact assessment may comprise applying one or more machine learning techniques. In some embodiments, performing the impact assessment may comprise performing what-if-scenarios task.

In some embodiments, the process 500 comprise at operation 508, generating a classification for the API request based on the predicted impact data. For example, the apparatus 200 may generate a classification for the API request based on the predicted impact data. In some embodiments, the classification is indicative and/or representative of acceptance or rejection of the predicted impact of implementation of the requested change reflected in the API request. For example, in some embodiments, the computing system 101 may be configured to generate an accept classification or a reject classification for the API request based on the predicted impact data. In this regard, the apparatus 200 may accept or reject the command corresponding the API request based on the classification.

In some embodiments, the process 500 comprise at operation 510, initiating the performance of one or more implementation actions based on the classification. For example, the apparatus 200 may initiate the performance of one or more implementation actions based on the classification. In some embodiments, the performance of the one or more implementation actions comprises transmitting the requested change reflected in the command to a flight management system in response to an accept classification. In some embodiments, the performance of the one or more implementation actions comprises transmitting a modified flight plan (e.g., based on the requested change) to a flight management system in response to an accept classification.

In some embodiments, the performance of the one or more implementation actions comprises transmitting a modified requested change to the flight management system in response to a reject classification. For example, the apparatus 200 may negotiate an acceptable change in response to a reject classification. In some embodiments, the performance of the one or more implementation actions comprises rendering a graphical user interface comprising a modified flight plan or alert on a display of the client computing device 102.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a command associated with a flight;
generating, using a conversion model, an API request corresponding to the command based on an API schema associated with a connected API for one or more connected applications, wherein the API request comprises one or more flight parameters from the command mapped to a lexicon associated with the API schema;
performing an impact assessment based on the API request to generate predicted impact data;
generating a classification for the API request based on the predicted impact data; and
initiating performance of one or more implementation actions based on the classification.

2. The computer-implemented method of claim 1, wherein the conversion model comprises a generative AI model.

3. The computer-implemented method of claim 1, wherein the command comprises a text command.

4. The computer-implemented method of claim 1, wherein the command comprises a voice command.

5. The computer-implemented method of claim 1, wherein generating the API request comprises:
parsing the command to extract the one or more flight parameters; and
mapping the one or more flight parameters to one or more corresponding terms within the lexicon.

6. The computer-implemented method of claim 1, wherein the command comprises a requested change associated with the one or more flight parameters defined in a flight plan associated with the flight.

7. The computer-implemented method of claim 6, wherein generating the predicted impact data comprises applying the requested change to the flight plan and assessing impact of the requested change on one or more primary flight parameters.

8. The computer-implemented method of claim 7, wherein the one or more primary flight parameters comprise one or more of fuel consumption or estimated time of arrival.

9. The computer-implemented method of claim 1, wherein the performance of the one or more implementation actions comprises transmitting one or more computer-executable instructions configured to provide a modified flight plan to a flight management system.

10. An apparatus comprising at least one processor and at least one memory storing instructions that, when executed by the at least one processor, cause the apparatus to:
receive a command associated with a flight;
generate, using a conversion model, an API request corresponding to the command based on an API schema associated with a connected API for one or more connected applications, wherein the API request comprises one or more flight parameters from the command mapped to a lexicon associated with the API schema;
perform an impact assessment based on the API request to generate predicted impact data;
generate a classification for the API request based on the predicted impact data; and
initiate performance of one or more implementation actions based on the classification.

11. The apparatus of claim 10, wherein the conversion model comprises a generative AI model.

12. The apparatus of claim 10, wherein the command comprises a text command.

13. The apparatus of claim 10, wherein the command comprises a voice command.

14. The apparatus of claim 10, wherein generating the API request comprises:
parsing the command to extract the one or more flight parameters; and
mapping the one or more flight parameters to one or more corresponding terms within the lexicon.

15. The apparatus of claim 10, wherein the command comprises a requested change associated with the one or more flight parameters defined in a flight plan associated with the flight.

16. The apparatus of claim 15, wherein generating the predicted impact data comprises applying the requested change to the flight plan and assessing impact of the requested change on one or more primary flight parameters.

17. The apparatus of claim 16, wherein the one or more primary flight parameters comprise one or more of fuel consumption or estimated time of arrival.

18. The apparatus of claim 10, wherein the performance of the one or more implementation actions comprises transmitting one or more computer-executable instructions configured to provide a modified flight plan to a flight management system.

19. At least one non-transitory computer-readable storage medium, the at least one non-transitory computer-readable storage medium having computer coded instructions configured to, when executed by at least one processor:
receive a command associated with a flight;
generate, using a conversion model, an API request corresponding to the command based on an API schema associated with a connected API for one or more connected applications, wherein the API request comprises one or more flight parameters from the command mapped to a lexicon associated with the API schema;
perform an impact assessment based on the API request to generate predicted impact data;
generate a classification for the API request based on the predicted impact data; and
initiate performance of one or more implementation actions based on the classification.

20. The at least one non-transitory computer-readable storage medium of claim 19, wherein the conversion model comprises a generative AI model.
